(19) United States
(12) Patent Application Publication
(10) Pub. No.: US 2013/0136374 A1
(43) Pub. Date: May 30, 2013

(54) METHOD AND APPARATUS FOR ENCODING THAT INTRA PREDICTION BASED ON MODE OF VARIABLE SIZE PARTITION IS APPLIED IN MACRO BLOCK

(71) Applicant: ELECTRONICS AND TELECOMMUNICATIONS, Daejeon (KR)

(72) Inventors: Eunjin KO, Daejeon (KR); Sangwook PARK, Daejeon (KR); Noh-Sam PARK, Daejeon (KR); Hyun Chul KANG, Daejeon (KR); Mi Ryong PARK, Daejeon (KR); Mi Kyong HAN, Daejeon (KR); Ji Sang KOH, Daejeon (KR); Jong Hyun JANG, Daejeon (KR); Kwang Roh PARK, Daejeon (KR)

(73) Assignee: ELECTRONICS AND TELECOMMUNICATIONS RESEARCH INSTITUTE, Daejeon (KR)

(21) Appl. No.: 13/647,729

(22) Filed: Oct. 9, 2012

(30) Foreign Application Priority Data
Nov. 28, 2011 (KR) 10-2011-0125087

(51) Int. Cl. G06T 9/00

(52) U.S. Cl. 382/238

(57) ABSTRACT

A method for encoding that adaptive intra prediction based on a mode of variable size partition is applied in a macro block, includes calculating average values of the macro blocks to set the representative values of the macro blocks; and generating minor macro blocks by partitioning the macro blocks based on partition of the exceeded portion and calculating average values of each of the minor macro blocks and then, setting representative values of each of the minor macro blocks using the calculated average values. Further, the method includes generating minor macro blocks by partitioning the macro blocks based on partition of horizontal and vertical directions, calculating average values of each of the minor macro blocks and then, setting representative values of each of the minor macro blocks using the calculated average values.

### CROSS-REFERENCE TO RELATED APPLICATION(S)

The present invention claims priority of Korean Patent Application No. 10-2011-0125087, filed on Nov. 28, 2011, which is incorporated herein by reference.

### FIELD OF THE INVENTION

The present invention relates to setting of representative values based on a mode of variable size partition in macro blocks; and more particularly, to a method and an apparatus, which are capable of maintaining a compression rate while preventing deterioration in image quality by reducing a difference between the representative values and each pixel value based on differential application of representative values according to sizes of macro blocks without setting the representative values of the corresponding macro blocks to average values of all pixels for the macro blocks, when applying an intra prediction mode to variable size macro blocks.

### BACKGROUND OF THE INVENTION

In an image compression field, when using an inter prediction mode for partitioning P or B frames into variable size macro blocks, two operations for compressing pixel values within the macro blocks are performed. A first operation is a motion vector value processing operation of searching macro blocks most similar to pixel values of macro blocks to calculate a positional difference between the corresponding macro blocks and a second operation is a motion compensation operation of calculating a deviation in pixel values between macro blocks to be compressed and blocks to be compared.

The motion compensation operation compresses only the pixel deviation values to reduce compression object information, thereby increasing compression efficiency.

Meanwhile, the related art starts partition sizes of MBs from 16*16 in the P frame and partitions the MBs into shaped sizes of 16*8, 8*16, 8*8, 4*8, 8*4, and 4*4, thereby processing inter prediction. In this case, the inter prediction discards high frequency values by a DCT mode and processes DCT coefficients as representative values. In addition, in accordance with the related art of the variable size mode, when partitioning and processing the macro blocks, intra prediction may be often performed according to characteristics of the variable size macro blocks even within the P frame. When performing the intra prediction, the overall average of pixel values within the macro blocks is considered as the representative values.

However, when the sizes of the variable size macro blocks are small, the difference between the representative values and each pixel value is not large and as a result, the representative values are used as the average pixel values, such that the deterioration in image quality hardly Occurs. On the other hand, when the sizes of the macro block are large, the difference between the representative values and each pixel value is large and therefore, the compression rate is better but the deterioration in image quality may occur.

### SUMMARY OF THE INVENTION

In view of the above, the present invention provides a method and an apparatus, which are capable of maintaining a compression rate while preventing deterioration in image quality by reducing a difference between the representative values and each pixel value based on differential application of representative values according to sizes of macro blocks without setting the representative values of the corresponding macro blocks to average values of all pixels for the macro blocks, when applying an intra prediction mode according to partition of macro blocks.

Objects of the embodiment of the present invention are not limited the above-mentioned objects and other objects may be apparently understood to a person skilled in the art to which the present invention pertains from the following description.

In accordance with a first aspect of the present invention, there is provided a method for encoding that adaptive intra prediction based on a mode of variable size partition is applied in a macro block for setting representative values of each of the macro blocks when performing intra prediction encoding by partitioning a P/B frame into at least one macro block having different sizes. The method for encoding includes when horizontal and vertical sizes of the macro blocks are a reference size or less, calculating average values of the macro blocks to set the representative values of the macro blocks; when the horizontal or vertical sizes of the macro blocks exceed the reference size, generating minor macro blocks by partitioning the macro blocks based on partition of the exceeded portion and calculating average values of each of the minor macro blocks and then, setting representative values of each of the minor macro blocks using the calculated average values; and when the horizontal and vertical sizes of the macro blocks exceed the reference size, generating minor macro blocks by partitioning the macro blocks based on partition of horizontal and vertical directions and calculating average values of each of the minor macro blocks and then, setting representative values of each of the minor macro blocks using the calculated average values.

In accordance with a second aspect of the present invention, there is provided a method for encoding that intra prediction based on a mode of variable size partition is applied in a macro block. The method for encoding includes when frames for encoding are input, partitioning the frames into a predetermined number of macro blocks having different sizes; performing first encoding on one of the predetermined number of macro blocks by a method for encoding inter prediction; performing second encoding on the macro blocks by a method for setting representative values of each of the minor macro blocks after generating minor macro blocks by partitioning one of the predetermined number of macro blocks based on comparison of vertical and horizontal lengths thereof with a reference size; and adding result values of the first or second encoding to encoding information of the frames by comparing results obtained by performing the first encoding and the second encoding on one of the predetermined number of macro blocks, wherein said performing first encoding, performing second encoding, and adding result values of the first or second encoding to encoding information of the frames are repeatedly performed predetermined times to encode the frames.

In accordance with a third aspect of the present invention, there is provided An apparatus for encoding that intra prediction based on a mode of variable size partition is applied in a macro block, including: when frames for encoding are input, a macro block partition unit configured to partition the frames into a predetermined number of macro blocks having different sizes to generate a macro block list;

a first encoding unit configured to sequentially read the macro blocks based on the macro block list and performing the encoding on the read macro blocks (macro blocks to be processed) by a method for encoding inter prediction to generate first result values; a second encoding unit configured to perform second encoding on the macro blocks by a method for generating minor macro blocks by partitioning the macro blocks to be processed based on comparison between vertical and horizontal lengths of the macro blocks to be processed with a reference size and then setting representative values of each of the minor macro blocks to generate second result values; and a comparison processing unit configured to add the first or second result values to encoding information of the frames by comparing the first and second result values stored in the storage unit.

In accordance with the embodiments of the present invention, when applying the intra prediction in the method for compressing the variable size macro blocks within the P frame used so as to increase the compression efficiency according to the image characteristics in the image compression method of the related art, the method for calculating the representative pixel values within the corresponding macro blocks is performed with reference to the size of the macro blocks to reduce the error from the pixel values within the blocks, thereby maintaining the compression efficiency while preventing the deterioration in image quality.

### BRIEF DESCRIPTION OF THE DRAWINGS

The objects and features of the present invention will become apparent from the following description of embodiments given in conjunction with the accompanying drawings, in which:

FIG. 1 is a diagram illustrating an image sequence configuration of image compression;

FIG. 2 is a diagram for describing an image compression method applied to the embodiment of the present invention;

FIG. 3 is a block diagram illustrating an apparatus for performing encoding by setting representative values according to sizes of macro blocks in accordance with the embodiment of the present invention;

FIGS. 4A to 4D are diagrams illustrating a data structure and an example of encoding used at the time of applying intra prediction in a P/B frame in accordance with the embodiment of the present invention; and

FIGS. 5A and 5B are flow charts illustrating a process of setting representative values according to sizes of macro blocks at the time of applying intra prediction to variable size macro blocks of a P/B frame in accordance with the embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims. Like reference numerals refer to like elements throughout the specification.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, an apparatus and a method for differentially applying representative values according to sizes of macro blocks without setting representative values of the corresponding macro blocks to average values of all pixels for the macro blocks at the time of applying an intra prediction mode according to variable size partition in the macro blocks.

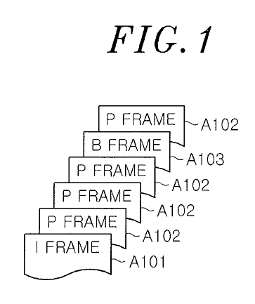

Prior to describing an embodiment of the present invention, an image sequence of image compression will be described with reference to FIG. 1.

FIG. 1 is a diagram illustrating image sequence configuration of image compression.

As shown in FIG. 1, an image is configured of an I frame A101, a P frame A102, and a B frame A103. A compression method is divided into a method applied to the I frame A101 and a method applied to the P frame A102 and the B frame A103.

The I frame A101 may serve as a seed image and may also serve as a reference frame of the P frame A102 and the B frame A103.

The P frame A102 may consecutively appear in plural and the B frame A103 may refer to frames that are present before and after the A frame 102.

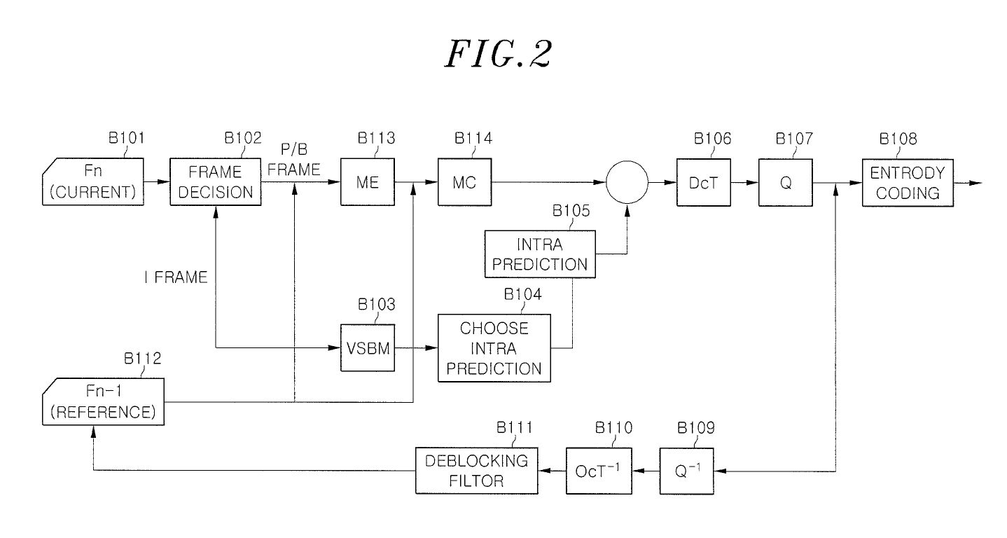

A basic concept of compressing an image having a configuration as described above will be described with reference to FIG. 2.

FIG. 2 is a diagram for describing an image compression method applied to the embodiment of the present invention.

As shown in FIG. 2, the image compression reads a current frame B101. The read current frame B101 may be the I frame A101 at the time of starting the image compression and may be the P frame A102 and the B frame A103 at the time of starting the image compression in advance.

The read current frame B101 has different processing modes according to a frame type and therefore, a confirmation operation for the frame type is performed (B102). When the frame type is the I frame A101, the macro blocks are partitioned from 16*16 to 4*4 sizes by a top-down mode so as to perform intra prediction. Hereinafter, adaptive intra prediction is selected B104 and the selected intra prediction is applied B105. Next, in order to increase the compression efficiency, compression is performed by discrete cosine transform (DcT) B106, quantization B107, and entropy coding B108. By this configuration, in order to use the I frame A101 as a reference frame of a next frame only when the compression for the I frame A101 ends, resultants subjected to the quantization B107 is subjected to dequantization B109, inverse DcT B110, deblocking filtering B111 processes to generate the reference frame.

When the next frame appears, a frame type is confirmed B102. In case of the P or B frame, the next frame compares with the reference frame B112 to calculate motion estimation B113, motion compensation is processed B114, and like the I frame processing, the DcT 106, quantization B107, and entropy coding B108 processes are performed to perform compression.

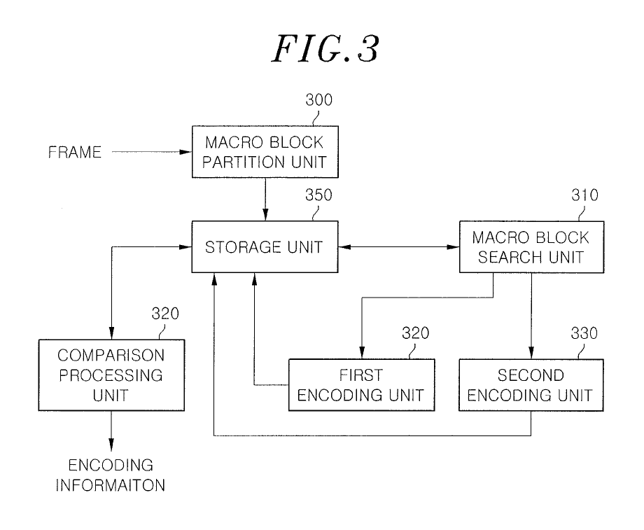

FIG. 3 is a block diagram illustrating an apparatus for performing encoding by setting representative values according to sizes of macro blocks in accordance with the embodiment of the present invention. The apparatus for performing encoding may include a macro block partition unit 300, a macro block search unit 310, a first encoding unit 320, a second encoding unit 330, and a comparison processing unit 340, and the like. In this configuration, the first encoding unit 320 performs encoding with an inter prediction mode and the second encoding unit 330 performs encoding with an intra prediction mode.

The macro block partition unit 300 may partition the corresponding frame into a variable size, that is, a predetermined number of macro blocks having different sizes when the frame for encoding, for example, the P or B frame is input, generate a macro block list by gathering neighboring blocks of the partitioned macro blocks, and then, store the macro block list in a storage unit 350.

The macro block search unit 310 may sequentially search the macro blocks in the macro block list and then, search the macro blocks most similar to pixel values of the macro blocks (hereinafter, referred to as ‘macro block to be processed’) searched in a reference frame and provide the searched macro blocks having high similarity and the macro blocks to be processed to the first encoding unit 320.

The first encoding unit 320 may use the macro blocks to be processed and the macro blocks having high similarity to perform an inter prediction process, perform encoding with motion vector values and motion compensation values that are the performed result values, and then, temporarily store the encoded results in the storage unit 350.

Meanwhile, the second encoding unit 330 may perform the intra prediction b a method of collecting information on horizontal and vertical lengths of the macro blocks to be processed and partitioning the macro blocks to be processed by comparing predetermined reference sizes, for example, 16 pixels, and then, setting representative values of each partitioned portion.

That is, when the horizontal length is 16 pixels or less and the vertical length is 16 pixels or less, the representative values of the macro blocks to be processed may be calculated using the average values of all pixels, when the vertical length is 17 or more, the macro blocks to be processed may be vertically partitioned into two and then, the average pixel values of each partitioned portion may be calculated to calculate the representative values of each portion, when the horizontal length is 17 or more, the blocks to be processed may be horizontally partitioned and then, the average pixel values of each horizontal portion may be calculated to calculate the representative values of each portion, when both of the horizontal and vertical lengths are 17 or more, the macro blocks to be processed may be horizontally and vertically partitioned and then, the average pixel values of each horizontal and vertical portion may be calculated to calculate the representative values of each portion.

The second encoding unit 330 performs the encoding based on the result values calculated by the foregoing method and the encoded result values may be temporarily stored in the storage unit 350.

The comparison processing unit 340 may compare the encoded result values of the first encoding unit 320 stored in the storage unit 350 with the encoded result values of the second encoding unit 330 and then, add the encoded result values having the small number of encoding bits to the encoding information of the corresponding frames.

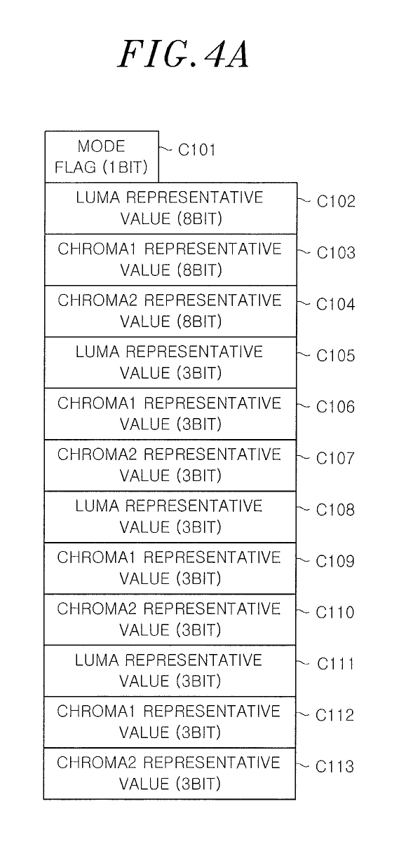

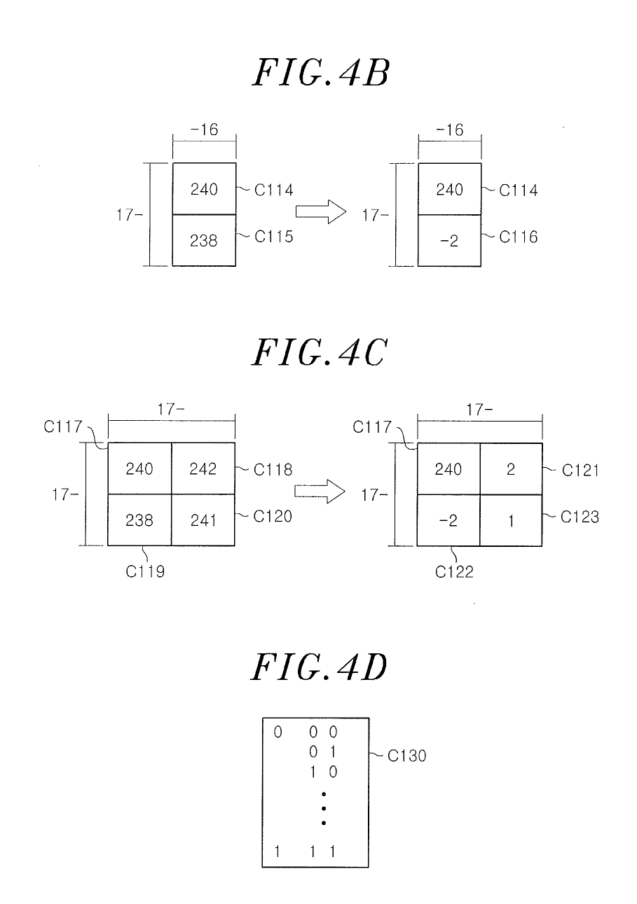

A data structure used when applying the intra prediction in the embodiment of the present invention will be described with reference to FIGS. 4A to 4D.

FIGS. 4A to 4D are diagrams illustrating a data structure and an example of encoding used at the time of applying intra prediction in a P/B frame in accordance with the embodiment of the present invention.

Reviewing the data structure diagram, as illustrated in FIGS. 4A to 4D, a mode of the corresponding macro blocks among the inter prediction and the intra prediction in the P frame A102 and the B frame A103 is recorded in a mode flag C101.

In case of the mode flag C101 is the intra prediction, when the horizontal and vertical block sizes are 16 pixels or less according to the sizes of the macro blocks, the representative values of the corresponding macro blocks are filled in Luma C102, Chroma1 C103, and Chroma2 C104. However, when one of the sizes of the horizontal or vertical blocks of the macro blocks is 16 pixels or less, a block that is 17 pixels or more is partitioned half to calculate representative values of two pixels and YUV pixel values of a minor macro block C114 present at the top left are filled in Luma C102, Chroma1 C103, and Chroma2 C104 and YUV pixel values of the remaining minor macro block C115 are filled in Luma C105, Chroma1 C106, and Chroma2 C107, that is, difference values between the YUV pixel values of the minor macro block C114 present at the top left and the YUV pixel values of the remaining minor macro block C115 are filled in the Luma C105, the Chroma1 C106, and the Chroma2 C107.

In addition, as illustrated in FIG. 4C, when both of the horizontal and vertical sizes of the macro blocks are 17 pixels, the macro blocks are partitioned into four and then, four representative pixel values are calculated and difference values from the Luma representative value C105 to the Charoma2 representative value C113 based on a minor macro block C117 at the top left are filled in the corresponding minor macro blocks C121, C122, and C123.

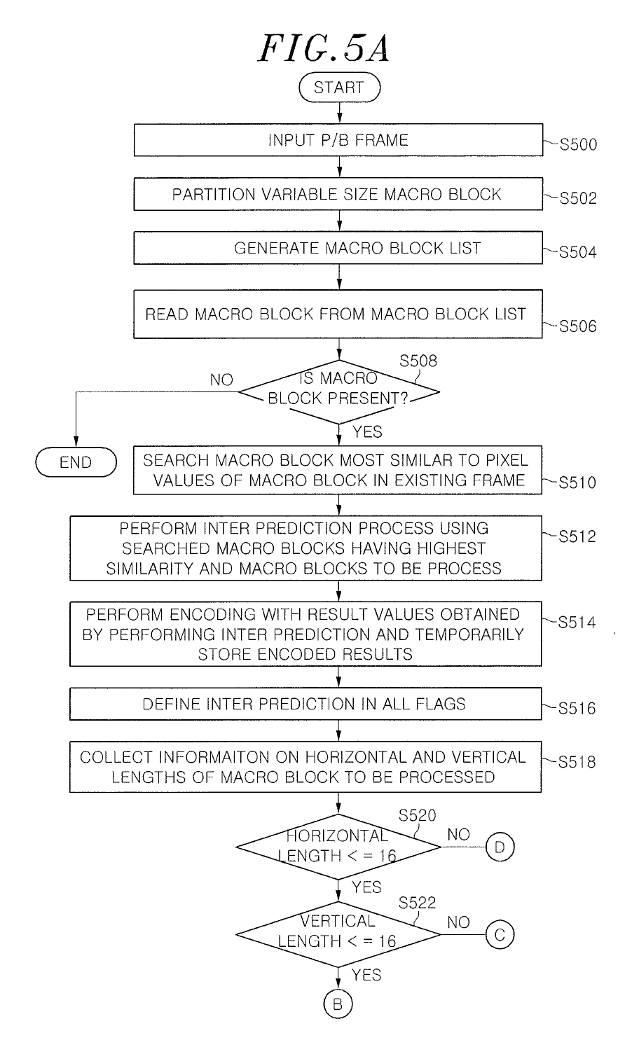

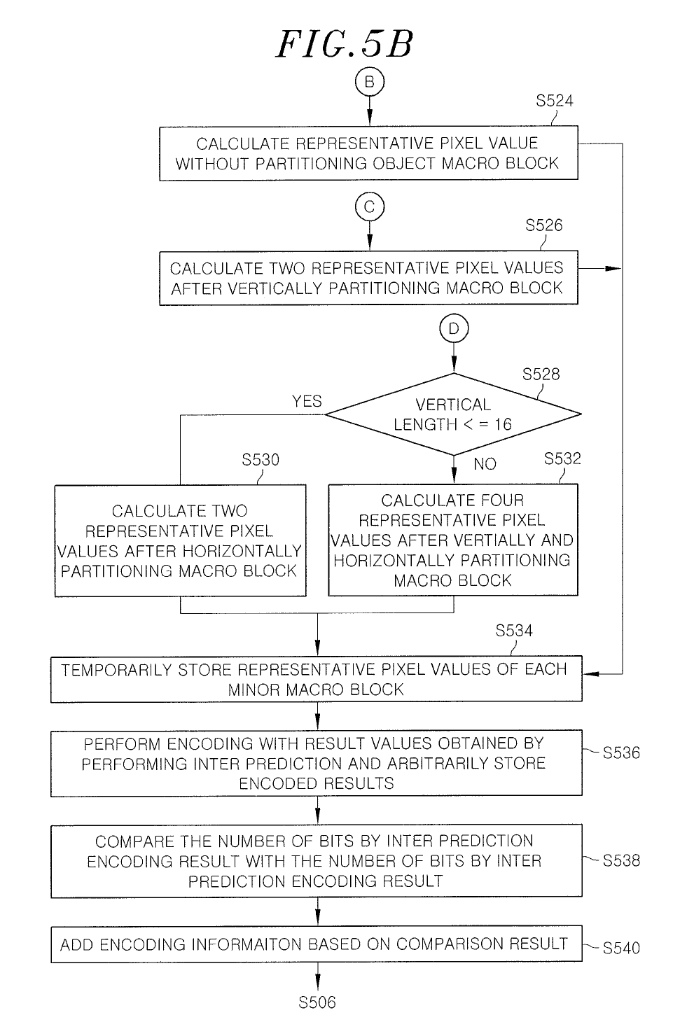

When the values are filled in the corresponding minor macro blocks, as illustrated in FIG. 4D, 3 bits are required and when the difference values are a positive number, a first bit is filled with 0 and when the difference values are a negative number, is filled with 1, and the remaining 2 bits is filled with 00 to 11 that are the difference value (C130). A process of setting the representative values according to the sizes of the macro blocks when the encoding apparatus having the structure as described above applies the intra prediction to the variable size macro blocks in the P or B frame will be described with reference to FIGS. 5A and 5B.

FIGS. 5A and 5B are flow charts illustrating a process of setting the representative values according to the sizes of the macro blocks at the time of applying the intra prediction to the variable size macro blocks of the P/B frame in accordance with the embodiment of the present invention.

As shown in FIG. 5A, when the P frame A102 or the B frame A103 are input in step S500, the macro block partition unit 300 partitions the corresponding frames into the variable size macro blocks in step S502. Then, the macro block list is generated by gathering the neighboring blocks of the partitioned macro blocks in step S504 and then, stored in the storage unit 350.

Thereafter, the macro block search unit 310 sequentially reads the macro blocks from the macro block list in step S506 and determines whether the read macro blocks are present in step S508.

If it is determined that the macro blocks are not present in step S508, the encoding ends. On the other hand, if it is determined that the macro blocks are present in step S508, the macro blocks most similar to the pixel values of the macro blocks to be processed and the macro blocks are searched in the reference frame B112 in step S510. The first encoding unit 320 may use the macro blocks having highest similarity and the macro blocks to be processed to perform the inter prediction process in step S512, perform the encoding with the motion vector values and the motion compensation values that are the result values obtained by performing the inter prediction, and then, temporarily store the encoded results in the storage unit 350 in step S514.

Next, the second encoding unit 330 performs the intra prediction for comparing with the inter prediction result values. First, the intra prediction is defined in the mode flag C101 and then, the information regarding the horizontal and vertical lengths of the macro blocks to be processed is collected in step S518.

Then, whether the horizontal length is 16 or less is determined in step S520. If it is determined that the horizontal length is 16 or less in step S520, whether a vertical length is 16 or less is also determined in step S522. If it is determined that the vertical length is also 16 or less in step S522, the representative pixel values of the macro blocks to be processed are calculated using the following Equation 1. In other words, referring to FIG. 5B, the representative pixel values of the macro blocks to be processed are calculated using the following Equation 1 without being partitioned in step S524 and then, the calculated representative pixel values are temporarily stored in the storage unit 350 in step S534.

Pᵣ₀=Σⁿᵢ₌₁Σ^{k}ⱼ₌₁P(i,j)/n*k [Equation 1]

In the above Equation 1, i represents a width, j represents a length, a horizontal length is represented by n, and a vertical length represented by k. P (i, j) represents pixel values in which a width and a length each are i and j and an average of all the pixel values of the macro blocks to be processed is calculated.

In step S522, it is determined that the vertical length is 17 or more, the macro blocks to be processed is vertically partitioned into two and then, the representative pixel values of the minor macro blocks at the top and the representative pixel values of the minor macro blocks at the bottom are calculated by the following Equation 2. In other words, when the vertical length exceeds 17, the macro blocks to be processed are vertically partitioned to generate the minor macro blocks at the top and bottom and the representative pixel values of each of the generated minor macro blocks are calculated by the following Equation 2 in step S526 and then, the representative pixel values of each of the calculated minor macro blocks are stored in the storage unit 350 in step S534.

Pᵣ₀=Σⁿᵢ₌₁Σ^{k}ⱼ₌₁P(i,j)/n*k

Pᵣ₁=Σⁿᵢ₌₁Σ^{k}ⱼ₌₁P(i,j)/n*k [Equation 2]

In step S520, if it is determined that the horizontal length is 17 or more, the process proceeds to step S528 to determine whether the vertical length is 16 or less. As a determination result, if it is determined that the vertical length is 16 or less in step S528, the macro blocks to be processed are horizontally partitioned and then, the representative pixel values of the minor macro blocks at the left and right are calculated using the above Equation 2 in step S530 and the representative pixel values of the minor macro blocks at the left and right are stored in the storage unit 350 in step S534.

On the other hand, if it is determined that the horizontal length is 17 or more in step S528, the macro blocks to be processed are vertically and horizontally partitioned into four and then, the representative pixel values of each of the minor macro blocks are calculated using the following Equation 3 in an order of the top left, the top right, the bottom left, and the bottom right in step S532.

Pᵣ₀=Σⁿᵢ₌₁Σ^{k}ⱼ₌₁P(i,j)/n*k

Pᵣ₁=Σⁿᵢ₌₁Σ^{k}ⱼ₌₁P(i,j)/n*k

Pᵣ₂=Σⁿᵢ₌₁Σ^{k}ⱼ₌₁P(i,j)/n*k

Pᵣ₃=Σⁿᵢ₌₁Σ^{k}ⱼ₌₁P(i,j)/n*k [Equation 3]

As described above, the representative pixel values of each of the calculated minor macro blocks in each case are stored in the data structures C102 to C113 in step S534 and then, the encoding is performed using the result values obtained by performing the intra prediction and then, the encoded results are temporarily stored in the storage unit 350 in step S536.

Next, the comparison processing unit 340 compares the encoded result values by the intra prediction with the encoded result values by the intra prediction in step S538 to add the P/B encoding information in step S540. In other words, when the number of encoded bits by the intra prediction is small, the encoded result values by the intra prediction are added to the P/B frame encoding information and when the number of encoded bits by the inter prediction is small, the encoded result values by the inter prediction are added to the P/B frame encoding information.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for encoding that adaptive intra prediction based on a mode of variable size partition is applied in a macro block for setting representative values of each of the macro blocks when performing intra prediction encoding by partitioning a P/B frame into at least one macro block having different sizes, the method comprising:
when horizontal and vertical sizes of the macro blocks are a reference size or less, calculating average values of the macro blocks to set the representative values of the macro blocks;
when the horizontal or vertical sizes of the macro blocks exceed the reference size, generating minor macro blocks by partitioning the macro blocks based on partition of the exceeded portion and calculating average values of each of the minor macro blocks and then, setting representative values of each of the minor macro blocks using the calculated average values; and
when the horizontal and vertical sizes of the macro blocks exceed the reference size, generating minor macro blocks by partitioning the macro blocks based on partition of horizontal and vertical directions, calculating average values of each of the minor macro blocks and then, setting representative values of each of the minor macro blocks using the calculated average values.

2. The method of claim 1, wherein the reference size is 16 pixels.

3. The method of claim 1, wherein said setting representative values of each of the minor macro blocks includes:
setting any one of the minor macro blocks as a reference and setting the average values of the set reference minor macro blocks as representative values of the reference minor macro blocks; and
setting representative values of other minor macro blocks by operating the representative values of the reference minor macro blocks and average values of other minor macro blocks.

4. The method of claim 3, wherein said setting representative values of other minor macro blocks includes:
calculating difference values between the representative values of the reference minor macro blocks and the average values of other minor macro blocks; and
setting the representative values of other minor macro blocks by calculating the difference values by a 3 bit value.

5. The method of claim 1, wherein said setting representative values of each of the minor macro blocks includes:
setting any one portion of the macro blocks divided by partitioning the horizontal and vertical directions as the reference minor macro blocks and setting the average values of the set reference minor macro blocks as the representative values of the reference minor macro blocks; and
calculating average values of each of the remaining minor macro blocks other than the reference minor macro blocks; and
setting the representative values of the remaining minor macro blocks by operating the representative values of the reference minor macro blocks and the average values of each of the remaining minor macro blocks.

6. The method of claim 5, wherein said setting the representative values of the remaining minor macro blocks includes:
calculating difference values between the representative values of the reference minor macro blocks and the average values of each of the remaining minor macro blocks; and
setting the representative values of each of the remaining minor macro blocks by calculating the difference values by a 3 bit value.

7. A method for encoding that intra prediction based on a mode of variable size partition is applied in a macro block, comprising:
when frames for encoding are input, partitioning the frames into a predetermined number of macro blocks having different sizes;
performing first encoding on one of the predetermined number of macro blocks by a method for encoding inter prediction;
performing second encoding on the macro blocks by a method for setting representative values of each of the minor macro blocks after generating minor macro blocks by partitioning one of the predetermined number of macro blocks based on comparison of vertical and horizontal lengths thereof with a reference size; and
adding result values of the first or second encoding to encoding information of the frames by comparing results obtained by performing the first encoding and the second encoding on one of the predetermined number of macro blocks,
wherein said performing first encoding, performing second encoding, and adding result values of the first or second encoding to encoding information of the frames are repeatedly performed predetermined times to encode the frames.

8. The method of claim 7, wherein said performing second encoding on the macro blocks includes, when horizontal and vertical sizes of any macro blocks are a reference size or less, performing the second encoding on any macro blocks by setting representative values based on calculation of average values of any macro blocks.

9. The method of claim 7, wherein said performing second encoding on the macro blocks further includes:
when horizontal or vertical sizes of any macro blocks exceed the reference size, generating the minor macro blocks by partitioning the exceeded portion; and
performing the second encoding on any macro blocks by calculating average values of each of the minor macro blocks and then, setting representative values of the minor macro blocks using the calculated average values.

10. The method of claim 7, wherein said performing second encoding on the macro blocks further includes:
when the horizontal and vertical sizes of any macro blocks exceed the reference size, generating the minor macro blocks by partitioning any macro blocks based on partition of horizontal and vertical directions; and
performing the second encoding on any macro blocks by calculating the average values of each of the minor macro blocks and then, setting representative values of each of the minor macro blocks using the calculated average values.

11. An apparatus for encoding that intra prediction based on a mode of variable size partition is applied in a macro block, comprising:
when frames for encoding are input, a macro block partition unit configured to partition the frames into a predetermined number of macro blocks having different sizes to generate a macro block list;
a first encoding unit configured to sequentially read the macro blocks based on the macro block list and performing the encoding on the read macro blocks (macro blocks to be processed) by a method for encoding inter prediction to generate first result values;
a second encoding unit configured to perform second encoding on the macro blocks by a method for generating minor macro blocks by partitioning the macro blocks to be processed based on comparison between vertical and horizontal lengths of the macro blocks to be processed with a reference size and then setting representative values of each of the minor macro blocks to generate second result values; and
a comparison processing unit configured to add the first or second result values to encoding information of the frames by comparing the first and second result values stored in the storage unit.

12. The method of claim 11, wherein the second encoding unit sets representative values based on calculation of average values of the macro blocks to be processed when horizontal and vertical sizes of the macro blocks to be processed are a reference size or less to generate the second result values of the macro blocks to be processed.

13. The apparatus of claim 11, wherein the second encoding unit generates the minor macro blocks based on partition of a exceeded portion when the horizontal or vertical sizes of the macro blocks to be processed exceed the reference size and calculates average values of each of the minor macro blocks and then, set representative values of each of the minor macro blocks using the calculated average values to generate second result values of the macro blocks to be processed.

14. The apparatus of claim 11, wherein the second encoding unit generates the minor macro blocks by partitioning the macro blocks to be processed based on partition of horizontal and vertical direction when the horizontal or vertical sizes of the macro blocks to be processed exceed the reference size and calculates average values of each of the minor macro blocks and then, set representative values of each of the minor macro blocks using the calculated average values to generate second result values of the macro blocks to be processed.
